(19) United States
(12) Patent Application Publication
(10) Pub. No.: US 2023/0307924 A1
(43) Pub. Date: Sep. 28, 2023

(54) POWER SUPPLY SYSTEM

(71) Applicant: Isuzu Motors Limited, Yokohama-shi (JP)

(72) Inventors: Futoshi YAMANE, Fujisawa-shi (JP); Takuya KIKUCHI, Fujisawa-shi (JP)

(73) Assignee: Isuzu Motors Limited, Yokohama-shi (JP)

(21) Appl. No.: 18/124,618

(22) Filed: Mar. 22, 2023

(30) Foreign Application Priority Data
Mar. 23, 2022 (JP) 2022-047127

(51) Int. Cl. H02J 7/00; H01M 10/42

(52) U.S. Cl. CPC H02J 7/00032; H02J 7/0013; H01M 10/425; H01M 2220/20

(57) ABSTRACT

A power supply system is capable of commonizing battery packs and reducing an increase in production costs. The power supply system includes a plurality of battery packs each including a terminating resistor, a control section that performs communication control on each of the battery packs via a communication line, and a harness that connects the terminating resistor included in any one of the battery packs to the communication line. The communication line extends in a predetermined direction along predetermined positions each corresponding to one of the battery packs, and the terminating resistor connected to the communication line is the terminating resistor included in the battery pack corresponding to the predetermined position located at the terminal end of the communication line in the predetermined direction, for example.

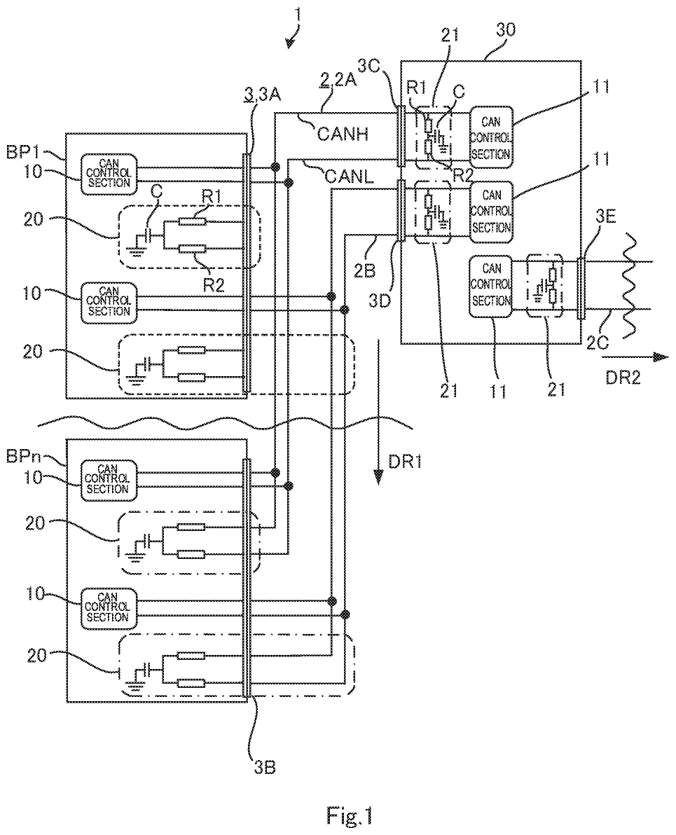

### CROSS REFERENCE TO RELATED APPLICATIONS

This application claims the benefit of priority of Japanese Patent Application No. 2022-047127 filed on Mar. 23, 2022, the contents of which are incorporated by reference as if fully set forth herein in their entirety.

### TECHNICAL FIELD

The present disclosure relates to a power supply system.

### BACKGROUND ART

When a high-frequency signal is passed through a communication line (a cable) having a terminal end that is cut off, a signal reflected from the cut surface and the original signal are mixed, causing a phenomenon that makes it difficult to read the signal. To prevent this phenomenon from occurring, it is common practice to connect a terminating resistor to the terminal end of the communication line.

In addition, a power supply system has been developed in which a plurality of battery packs are controlled by a control section.

For example, a power supply system has been disclosed that includes a plurality of battery packs, a control section connected to an upstream connector of a most upstream battery pack that is located at the most upstream end of the plurality of battery packs, a communication line that connects, among the plurality of battery packs, a downstream connector of an upstream battery pack located on the upstream side to an upstream connector of a downstream battery pack located immediately downstream of the upstream battery pack, and a terminating resistor connected to a downstream connector of the most downstream battery pack located at the most downstream end of the plurality of battery packs (refer to, for example, PTL 1).

### CITATION LIST

### Patent Literature

### PTL 1

WO 2012/120745

### SUMMARY OF INVENTION

### Technical Problem

To reduce the number of parts of a battery pack, it is planned to commonize battery packs.

However, since there is a difference in specification between battery packs with terminating resistors and battery packs without terminating resistors, it is difficult to commonize battery packs. In addition, since battery packs with terminating resistors and battery packs without terminating resistors are similar shaped parts, it is necessary to identify similar shaped parts on the production line, which increases the production costs.

The present disclosure provides a power supply system that includes commonized battery packs and decreases the production costs.

### Solution to Problem

In order to achieve the abovementioned object, a power supply system in the present disclosure, includes:
a plurality of battery packs each including a terminating resistor;
a control section configured to perform communication control on each of the battery packs via a communication line; and
a harness configured to connect the terminating resistor included in any one of the battery packs to the communication line.

### Advantageous Effects of Invention

According to the present disclosure, it is possible to commonize the battery packs and avoid an increase in production costs.

### BRIEF DESCRIPTION OF DRAWINGS

FIGURE is a block diagram of a power supply system according to an embodiment of the present disclosure.

### DESCRIPTION OF EMBODIMENTS

Exemplary embodiments of the present disclosure are described below with reference to the accompanying drawings. FIGURE is a block diagram of power supply system 1 according to an embodiment of the present disclosure.

Power supply system 1 illustrated in FIGURE is mounted in a vehicle, such as an electric vehicle or a hybrid vehicle.

Power supply system 1 includes plurality of battery packs BP, battery ECU 30, bus line 2 (corresponding to a “communication line” of the present disclosure), and harness 3. FIGURE illustrates an assembled battery composed of n battery packs BP1, . . . , BPn, where n is an integer greater than or equal to 2.

[Bus Line 2]

Bus line 2 includes bus lines 2A, 2B, and 2C. Bus line 2A extends from battery ECU 30 in predetermined DR1 direction (for example, the direction in which battery packs BP are arranged) along predetermined positions each corresponding to the position of one of plurality of battery packs BP. Bus line 2B extends from battery ECU 30 in predetermined DR1 direction along the predetermined positions each corresponding to the position of one of plurality of battery packs BP. According to the present embodiment, battery pack BP1 is disposed at a predetermined position corresponding to a base end in DR1 direction. Battery pack BPn is disposed at a predetermined position corresponding to a terminal end in DR1 direction. Bus line 2C extends in DR2 direction.

[Battery Pack BP]

Plurality of battery packs BP are physically composed of the same elements. More specifically, battery pack BP includes two CAN control sections 10 and two terminating resistors 20.

[CAN Control Section 10]

CAN control section 10 controls the balancing of the voltage of battery pack BP, monitors the abnormalities of the current, voltage, and temperature in battery pack BP, monitors the charging capacity of battery pack BP, monitors the level of deterioration of battery pack BP, controls a charge/discharge current of battery pack BP, detects the insulation resistance of battery pack BP, performs relay drive in battery pack BP, and the like.

[Terminating Resistor 20]

Terminating resistor 20 attenuates signal reflection from the cut surface of bus line 2. Terminating resistor 20 includes two resistors R1 and R2 and capacitor C. One terminal of resistor R1 is connectable to CANH line of bus line 2 by harness 3. One terminal of resistor R2 is connectable to CANL line of bus line 2 by harness 3. The other terminal of resistor R1 is connected to the other terminal of resistor R2. One terminal of capacitor C is connected to a connection point between the other terminal of resistor R1 and the other terminal of resistor R2. The other terminal of capacitor C is connected to ground.

The interrelationship among the type of harness 3, terminating resistor 20, and bus line 2 is described below.

[Harness 3A Case]

The interrelationship among harness 3A, terminating resistor 20, and bus line 2A for battery pack BP1 is described first. One terminal of resistor R1 is not connected to CANH line of bus line 2A by harness 3A. Similarly, one terminal of resistor R2 is not connected to CANL line of bus line 2A by harness 3A.

The interrelationship among harness 3A, terminating resistor 20, and bus line 2B for battery pack BP1 is described below. One terminal of resistor R1 is not connected to CANH line of bus line 2B by harness 3A. Similarly, one terminal of resistor R2 is not connected to CANL line of bus line 2B by harness 3A. One CAN control section 10 in battery pack BP1 is connected to bus line 2A by harness 3A. In addition, the other CAN control section 10 in battery pack BP1 is connected to bus line 2B by harness 3A.

[Harness 3B Case]

The interrelationship among harness 3B, terminating resistor 20, and bus line 2A for battery pack BPn is described below. One terminal of resistor R1 is connected to CANH line of bus line 2A by harness 3B. Similarly, one terminal of resistor R2 is connected to CANL line of bus line 2A by harness 3B.

The interrelationship among harness 3B, terminating resistor 20, and bus line 2B for battery pack BPn is described below. One terminal of resistor R1 is connected to CANH line of bus line 2B by harness 3B. Similarly, one terminal of resistor R2 is connected to CANL line of bus line 2B by harness 3B. One CAN control section 10 in battery pack BPn is connected to bus line 2A by harness 3B. The other CAN control section 10 in battery pack BPn is connected to bus line 2B by harness 3B.

[Battery ECU 30]

Battery ECU 30 includes three CAN control sections 11 and three terminating resistors 21. Three CAN control sections 11 are physically composed of the same elements. First one of CAN control sections 11 is connected to bus line 2A by harness 3C. Similarly, second one of CAN control sections 11 is connected to bus line 2B by harness 3D. Similarly, third one of CAN control sections 11 is connected to bus line 2C by harness 3E.

Three terminating resistors 21 are physically composed of the same elements. First one of terminating resistors 21 is connected to bus line 2A by harness 3C. Second one of terminating resistors 21 is connected to bus line 2B by harness 3D. Third one of terminating resistors 21 is connected to bus line 2C by harness 3E.

Terminating resistor 21 in battery ECU 30 is different from terminating resistor 20 in battery pack BP. Terminating resistor 21 includes two resistors R1 and R2 connected in series and capacitor C. Two series-connected resistors R1 and R2 are connected in parallel with CAN control section 11. One terminal of capacitor C is connected to a point between two resistors R1 and R2, and the other terminal of capacitor C is connected to ground.

Power supply system 1 according to the embodiment of the present disclosure includes plurality of battery packs BP each provided with terminating resistor 20, CAN control section 10 that performs communication control on each of plurality of battery packs BP via bus line 2, and harness 3 that connects terminating resistor 20 provided in any one of battery packs BP to bus line 2.

Since in power supply system 1 having the above-described configuration, each of plurality of battery packs BP includes terminating resistor 20, battery packs BP can be commonized. In addition, since battery packs BP are commonized, there is no need to identify parts having similar shapes on the production line and, thus, it is possible to reduce an increase in production costs.

Furthermore, in power supply system 1 according to the embodiment of the present disclosure, bus line 2 extends in a predetermined direction along predetermined positions each corresponding to one of plurality of battery packs BP, and terminating resistor 20 connected to bus line 2 is terminating resistor 20 provided in battery pack BP corresponding to the predetermined position located at the terminal end of bus line 2 in the predetermined direction. Thus, when terminating resistor 20 is provided at predetermined position in bus line 2, terminating resistor 20 provided in battery pack BP corresponding to the predetermined position can be connected to bus line 2 by harness 3, since terminating resistor is provided in each of battery packs BP.

Furthermore, as illustrated in FIGURE, power supply system 1 according to the embodiment of the present disclosure includes two bus lines 2A and 2B, and terminating resistor 20 is connected to each of two bus lines 2A and 2B. However, the two bus lines 2A and 2B are not necessarily required, and if one of two bus lines 2 is sufficient, terminating resistor 20 can be connected to bus line 2.

In addition, the above-described embodiments are merely examples of specific implementations of the present disclosure, and the technical scope of the present disclosure should not be construed to be limited by the embodiments. That is, the present disclosure can be embodied in various forms without departing from the spirit or essential characteristics thereof.

### INDUSTRIAL APPLICABILITY

The present disclosure is suitably used for vehicles provided with a power supply system that is required to commonize battery packs and reduce an increase in production costs.

### REFERENCE SIGNS LIST

CA, CB, CC CAN bus
1 Power supply system
2, 2A, 2B, 2C Bus line
3, 3A, 3B, 3C, 3D, 3E Harness
10, 11 CAN Control section
20, 21 Terminating resistor
30 Battery ECU

1. A power supply system, comprising:
a plurality of battery packs each including a terminating resistor;
a control section configured to perform communication control on each of the battery packs via a communication line; and
a harness configured to connect the terminating resistor included in any one of the battery packs to the communication line.

2. The power supply system according to claim 1, wherein the communication line extends in a predetermined direction along predetermined positions each corresponding to one of the battery packs, and
wherein the terminating resistor connected to the communication line is the terminating resistor included in the battery pack corresponding to the predetermined position located at a terminal end of the communication line in the predetermined direction.
